(19) United States
(12) Patent Application Publication
(10) Pub. No.: US 2026/0002346 A1
(43) Pub. Date: Jan. 1, 2026

(54) UNIVERSAL JOINT AND FAUCET EXTENDER WITH UNIVERSAL JOINT

(71) Applicant: HIGHPLUS INTERNATIONAL CO., LTD., New Taipei City (TW)

(72) Inventor: Chih-Hung KAO, New Taipei City (TW)

(21) Appl. No.: 18/754,799

(22) Filed: Jun. 26, 2024

(51) Int. Cl. E03C 1/04; F16L 27/047

(52) U.S. Cl. CPC E03C 1/0404; F16L 27/047

(57) ABSTRACT

A faucet extender has a universal joint and a water outlet device. The universal joint has a connecting base and a water outlet base. The connecting base has a lower connecting hole. The water outlet base has an installing part and a spherical joint. The installing part has an installing space, an installing hole and a through-hole. The installing hole and the through-hole connect two ends of the installing space. A flow channel is through the spherical joint and connects the through-hole. An end of the spherical joint is rotatably mounted in the connecting base and protrudes from the lower connecting hole. Another end of the spherical joint is mounted on the installing part. The water outlet device is mounted in the installing hole. In addition to the original downward water outlet direction of the faucet, the water outlet direction can be adjusted via rotating the water outlet base.

### BACKGROUND OF THE INVENTION

### Field of the Invention

The present invention relates to a universal joint, especially to a universal joint for a faucet extender.

### Description of the Prior Arts

A conventional faucet, especially a faucet used for a basin, has a single water outlet facing downwards. To increase the convenience of use, the user will install a faucet extender at the water outlet of the faucet. There are many types of faucet extenders. The more common types include robotic arm faucet extenders and universal swivel faucet extenders. The robotic arm faucet extender includes a connecting part, an arm and a water outlet part. An end of the arm pivots and connects the connecting part and another end of the arm pivots and connects the water outlet part. The connecting part is configured to be mounted on a faucet. The user can change the direction of the water by adjusting the arm and the water outlet part. For example, the water can be directed upward for the user to wash their face or gargle. The universal swivel faucet extender includes a fixing part and a water outlet part. An end of the fixing part extends downwardly with a universal joint and an end of the water outlet part connects the universal joint. Therefore, the user can change the angle of the water outlet by rotating the water outlet head with the universal joint as the center of rotation.

However, the robotic arm faucet extender is large in size and has a multi-joint structure. Taking up space and easily colliding with surrounding objects, in the process of adjusting the angle, each joint needs to be adjusted separately to achieve the ideal angle, so the overall operation is time-consuming and awkward. The rotation angle of the universal swivel faucet extender is limited, and it can only discharge water in the downward direction. When the rotation angle is large, the water outlet of the universal joint will be partially obscured by the surrounding structure, resulting in a decrease in water output and an occurrence of instability. Therefore, the overall structure of the conventional faucet extender has the problems and shortcomings mentioned above and needs to be improved.

To overcome the shortcomings, the present invention provides a universal joint and a faucet extender with a universal joint to mitigate or obviate the aforementioned problems.

### SUMMARY OF THE INVENTION

The main objective of the present invention is to provide a universal joint and a faucet extender that can be mounted on a faucet and can increase the angle range of the water outlet of the faucet.

The universal joint has a connecting base and a water outlet base. The connecting base has a connecting space, an upper connecting hole, and a lower connecting hole. The connecting space is formed in the connecting base. The upper connecting hole connects to an end of the connecting space and the lower connecting hole connects to another end of the connecting space. The water outlet base has an installing part and a spherical joint. The installing part has an installing space, an installing hole, and a through-hole. The installing space is formed in the installing part. The installing hole is formed at an end of the installing part and connects to the installing space. The through-hole is formed at another end of the installing part and connects to the installing space. An end of the spherical joint connects to the installing part. Another end of the spherical joint is mounted through the lower connecting hole and is rotatably mounted in the connecting space of the connecting base. The spherical joint has a flow channel through the spherical joint. An end of the flow channel connects to the through-hole and another end of the flow channel connects to the connecting space and the upper connecting hole.

The faucet extender comprises the universal joint mentioned above and a water outlet device. The water outlet device is mounted in the installing hole of the installing part.

The advantage of the present invention is that when the universal joint connects to the faucets, in addition to the original downward water outlet direction of the faucet, the user can tilt the water outlet direction of the water outlet device upward by rotating the water outlet base. When the water outlet direction is downward, it is convenient for users to wash hands or clean items. When the water outlet direction is upward, it is convenient for users to gargle or wash their face. In addition, the universal joint has a simple overall structure, a smaller size, and has the advantages of reduced cost and high versatility.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the first embodiment of a faucet extender with a universal joint;

FIG. 2 is a sectional view of the faucet extender in FIG. 1;

FIG. 3 is a sectional view of the usage state of the faucet extender in FIG. 1;

FIG. 4 is a perspective view of the second embodiment of a faucet extender with a universal joint;

FIG. 5 is a sectional view of the faucet extender in FIG. 4;

FIG. 6 is a sectional view of the first usage state of the faucet extender in FIG. 4;

FIG. 7 is a sectional view of the second usage state of the faucet extender in FIG. 4;

FIG. 8 is a sectional view of the third usage state of the faucet extender in FIG. 4;

FIG. 9 is a sectional view of the fourth usage state of the faucet extender in FIG. 4;

FIG. 10 a perspective view of the third embodiment of a faucet extender with a universal joint;

FIG. 11 is a sectional view of the faucet extender in FIG. 10; and

FIG. 12 is a sectional view of the usage state of the faucet extender in FIG. 10.

### DETAILED DESCRIPTION OF THE PREFERRED EMBODIMENTS

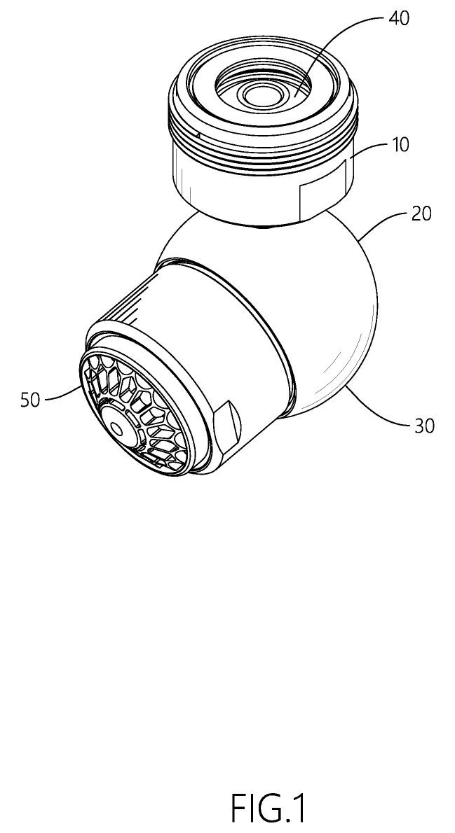

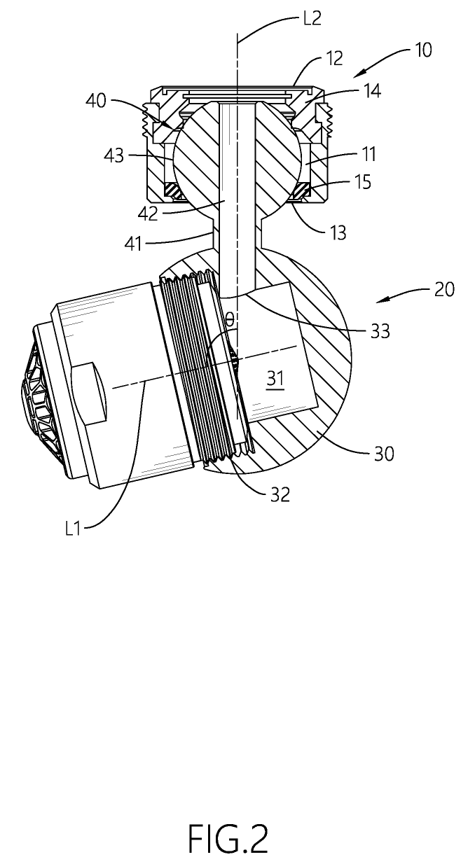

With reference to FIG. 1 to FIG. 4, a universal joint in accordance with the present invention comprises a connecting base 10 and a water outlet base 20.

The connecting base 10 is a hollow column and comprises a connecting space 11, an upper connecting hole 12, a lower connecting hole 13, an upper sealing ring 14 and a lower sealing ring 15. The connecting base 10 surrounds the connecting space 11. The upper connecting hole 12 and the lower connecting hole 13 connect to two opposite ends of the connecting space 11 respectively. In this embodiment, an external thread is formed at an outer wall of the connecting base 10 and close to the upper connecting hole 12, but it is not limited thereto, and the connecting base 10 can also form an internal thread. The upper sealing ring 14 is mounted in the connecting space 11 and close to the upper connecting hole 12. The lower sealing ring 15 is mounted in the connecting space 11 and close to the lower connecting hole 13. In another embodiment, the type of the connecting base 10 can be changed according to user needs, or the connecting base 10 may not comprise an upper sealing ring 14 and a lower sealing ring 15.

In the first embodiment, the water outlet base 20 comprises an installing part 30 and a spherical joint 40. The installing part 30 can be a sphere and comprises an installing space 31, an installing hole 32, a through-hole 33 and a first phantom line L1. The installing space 31 is formed in the installing part 30. The installing hole 32 and the through-hole 33 are formed at two ends of the installing part 30 respectively and connect to the installing space 31. An internal thread is formed at a wall of the installing hole 32, but it is not limited thereto. The first phantom line L1 extends along an axial direction of the installing hole 32.

The spherical joint 40 and the connecting base 10 connect to each other. Precisely, an end of the spherical joint 40 connects to the installing part 30. Another end of the spherical joint 40 is mounted through the lower connecting hole 13 and rotatably mounted in the connecting space 11 of the connecting base 10. The upper sealing ring 14 and the lower sealing ring 15 are sleeved on the spherical joint 40 respectively. The spherical joint 40 comprises an extending rod 41, a flow channel 42, an upper first joint 43 and a second phantom line L2. The extending rod 41 can be the end of the spherical joint 40 connecting to the installing part 30. The upper first joint 43 can be the end of the spherical joint 40 mounted through the lower connecting hole 13. Precisely, the upper first joint 43 is rotatably mounted in the connecting space 11 of the connecting base 10 and protrudes from the lower connecting hole 13 of the connecting base 10. In this embodiment, two ends of the extending rod 41 are securely mounted on the upper first joint 43 and the installing part 30 respectively, and the extending rod 41, the upper first joint 43, and the installing part 30 can be integrated by molding, such that the extending rod 41, the upper first joint 43, and the installing part 30 cannot rotate with respect to each other. The flow channel 42 is through the upper first joint 43 and extending rod 41 along an axial direction of the extending rod 41. An end of the flow channel 42 connects to the through-hole 33 and another end of the flow channel 42 connects to the connecting space 11 and the upper connecting hole 12. The second phantom line L2 extends along an axial direction of the flow channel 42. An angle θ between the first phantom line L1 and the second phantom line L2 is from 30 degrees to 180 degrees. In this embodiment, the angle θ is 150 degrees.

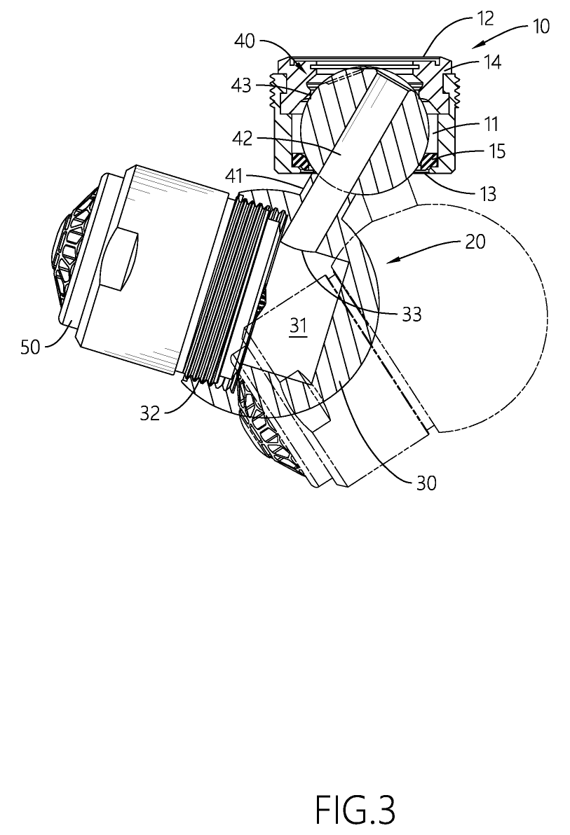

When the universal joint of the present invention is used in a faucet extender, the faucet extender comprises the universal joint mentioned above and a water outlet device 50. The upper connecting hole 12 of the connecting base 10 can be mounted at a water outlet of a faucet (not shown in the figure). In this embodiment, the water outlet device 50 can be an on-off valve. In another embodiment, the water outlet device 50 can be a flow aerator but it is not limited thereto. An end of the water outlet device 50 comprises an external thread and another end of the water outlet device 50 comprises a push button switch. This is a standard component of the prior art, and its detailed structure will not be described. The external thread of the water outlet device 50 is fixed with the internal thread of the installing hole 32 of the installing part 30. When the spherical joint 40 of the universal joint is rotated with respect to the connecting base 10, the universal joint can change the direction of the water outlet device 50. Therefore, the universal joint makes the direction of the water flowing out of the water outlet device 50 more varied. Precisely, in addition to the original downward water outlet direction of the faucet, when the user rotates the water outlet base 20 until the extending rod 41 abuts a lower edge of the connecting base 10, the water outlet base 20 can tilt the water outlet direction of the water outlet device 50 upward (shown in FIG. 3).

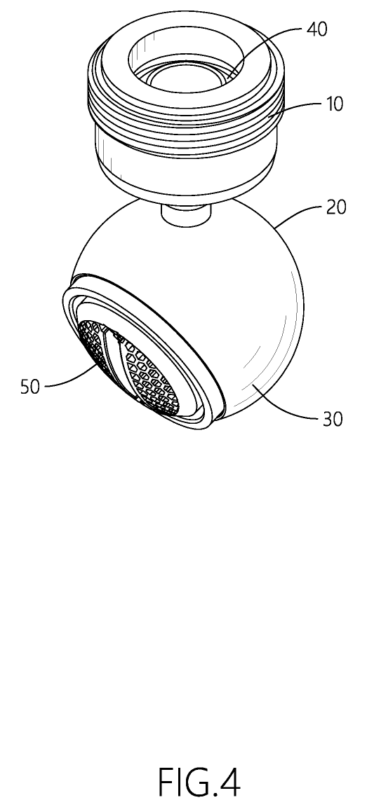

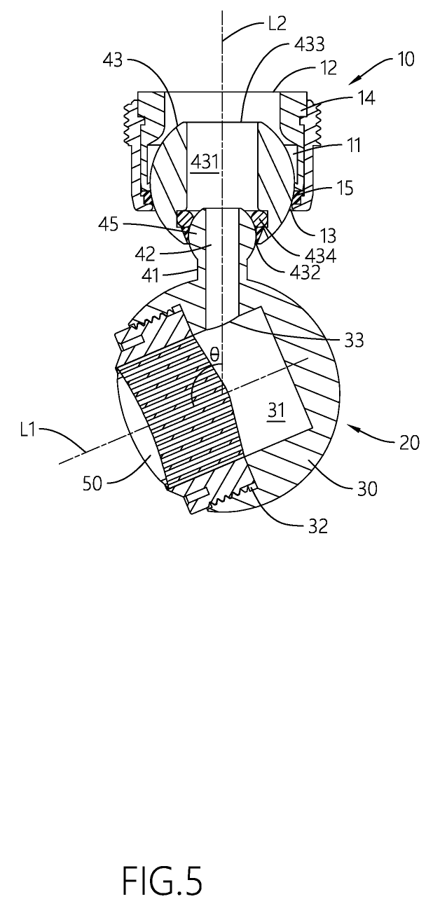

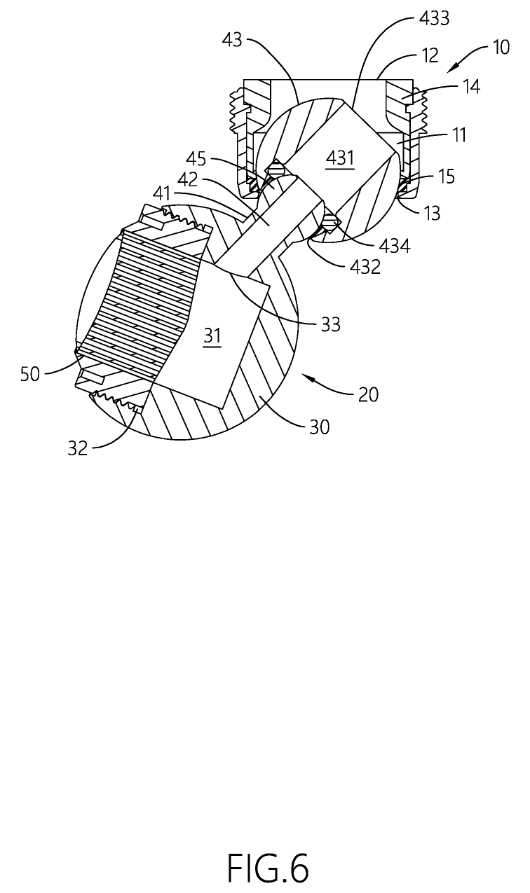

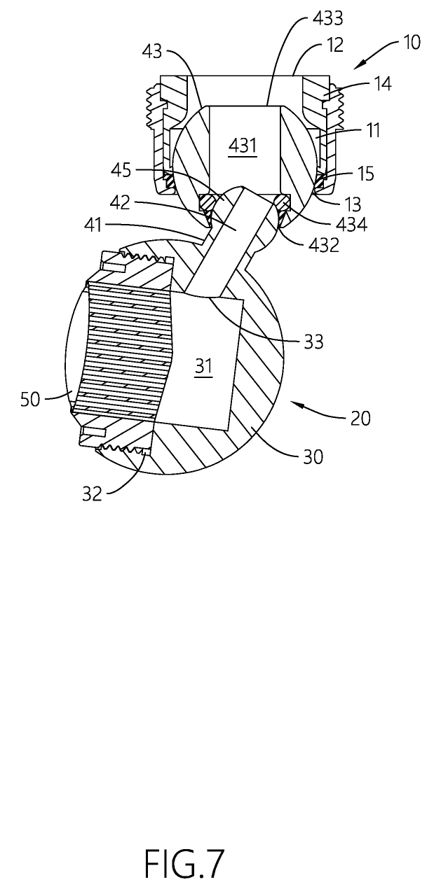

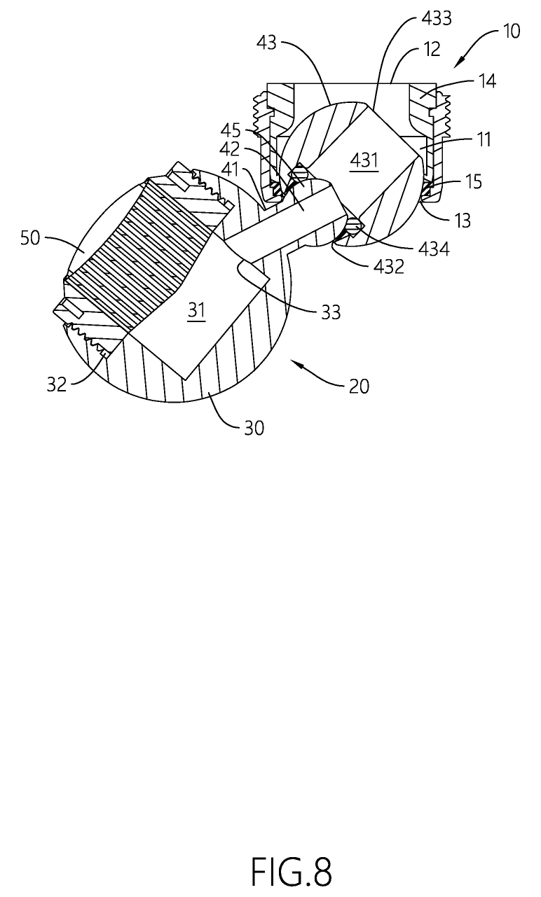

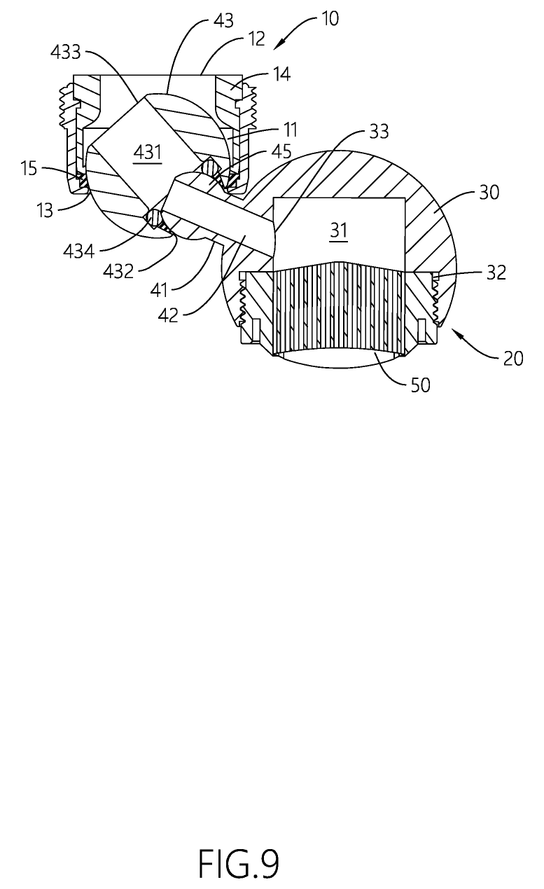

With reference to FIG. 4 to FIG. 9, the universal joint in the second embodiment is similar to the universal joint in the first embodiment. The difference is that the spherical joint 40 of the water outlet base 20 in the second embodiment further comprises an upper second joint 45 and the extending rod 41 can rotate with respect to the upper first joint 43. Precisely, the upper first joint 43 can comprise an upper joint holder 431, an opening 432, an upper water inlet 433, and an upper positioning ring 434. The upper joint holder 431 is through the upper first joint 43. The opening 432 and the upper water inlet 433 of the upper first joint 43 are respectively formed at two opposite ends of the upper joint holder 431. The upper water inlet 433 connects to the connecting space 11 and the upper connecting hole 12 of the connecting base 10. The upper positioning ring 434 is mounted in the upper joint holder 431 and close to the opening 432 of the upper first joint 43. The upper second joint 45 is rotatably mounted in the upper joint holder 431 and protrudes from the opening 432 of the upper first joint 43. The upper positioning ring 434 is sleeved on the upper second joint 45 to prevent the upper second joint 45 from escaping from the upper joint holder 431. The upper second joint 45 connects to one end of the extending rod 41. In this embodiment, the upper second joint 45 and the extending rod 41 are integrally formed and cannot rotate to each other. The flow channel 42 is through the upper second joint 45 and connects the opening 432 of the upper first joint 43.

Therefore, both the upper first joint 43 and the upper second joint 45 can rotate and make the universal joint have a wider rotation angle. For example, when the upper first joint 43 rotates to the maximum angle, the upper second joint 45 can be further rotated to increase the water outlet angle of the water outlet base 20. In other words, in the second embodiment, the rotatable angle range of the water outlet base 20 includes the rotatable angle range of the upper first joint 43 and the rotatable angle range of the upper second joint 45 (shown in FIG. 3). Compared with the universal joint of the first embodiment, the universal joint of the second embodiment has a wider range of rotation angle.

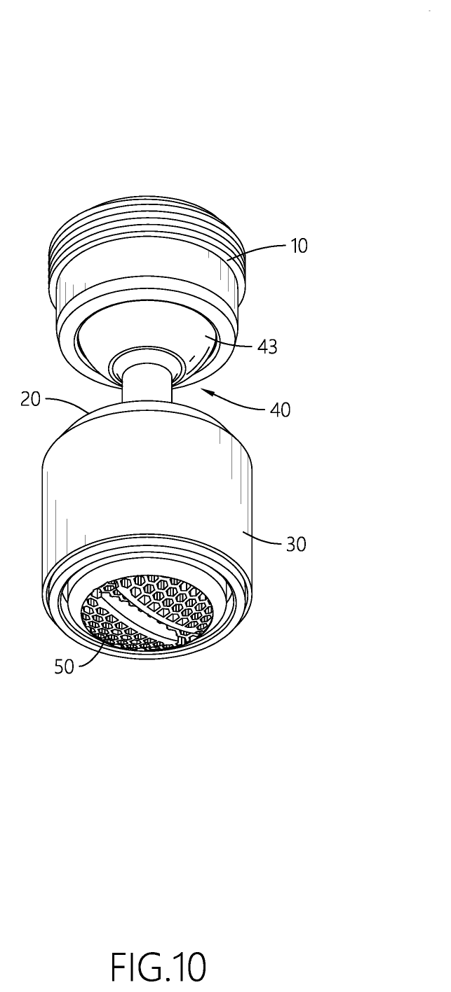

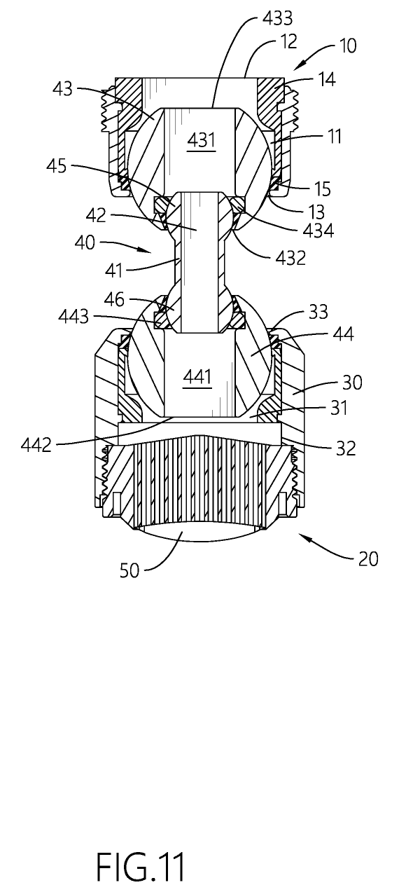

With reference to FIG. 10 to FIG. 12, the universal joint in the third embodiment is similar to the universal joint in the second embodiment. The difference is that the spherical joint 40 of the water outlet base 20 in the third embodiment further comprises a lower first joint 44 and a lower second joint 46. Precisely, the lower first joint 44 is rotatably mounted in the installing space 31 of the installing part 3 and protrudes from the through-hole 33 of the installing part 30. The lower first joint 44 comprises a lower joint holder 441, a lower water outlet 442, and a lower positioning ring 443. The lower joint holder 441 is through the lower first joint 44 and an end of the lower joint holder 441 connects to the flow channel 42. The lower water outlet 442 is formed at another end of the lower joint holder 441 and connects the installing space 31 and the lower joint holder 441. The lower positioning ring 443 is mounted in the lower joint holder 441 and away from the lower water outlet 442. The upper second joint 45 and the lower second joint 46 are respectively formed at the two opposite ends of the extending rod 41 and are integrally formed in this embodiment, but it is not limited thereto. The lower second joint 46 is rotatably mounted in the lower joint holder 441. The lower positioning ring 443 is sleeved on the lower second joint 46 to prevent the lower second joint 46 from escaping from the lower joint holder 441. The flow channel 42 is through the upper second joint 45, the extending rod 41, and the lower second joint 46 in order. The flow channel 42 connects the upper joint holder 431 and the lower joint holder 441.

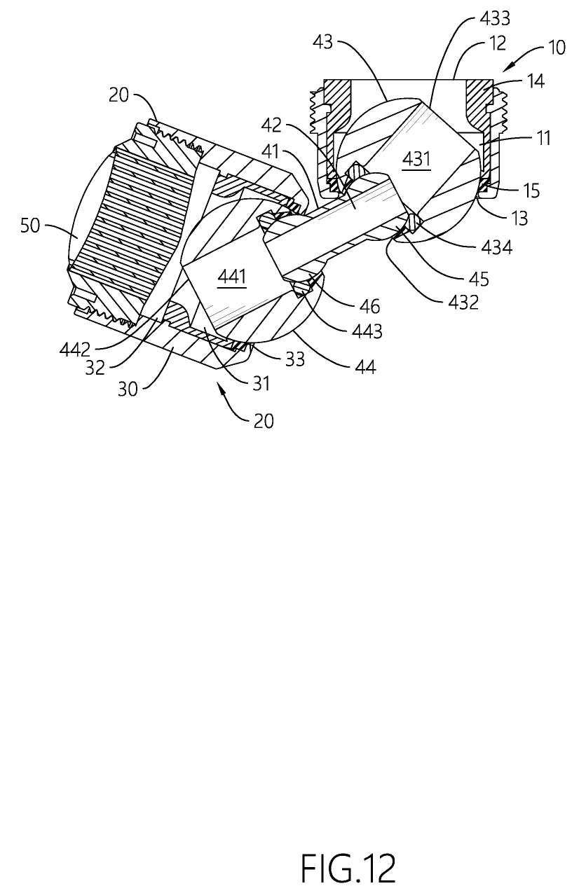

Therefore, when the upper first joint 43 and the upper second joint 45 rotate to the maximum angle, the lower first joint 44 and the lower second joint 46 can be further rotated to increase the water outlet angle of the water outlet base 20. In other words, in the third embodiment, the rotatable angle range of the water outlet base 20 includes the rotatable angle range of the upper first joint 43, the rotatable angle range of the upper second joint 45, the rotatable angle range of the lower first joint 44, and the rotatable angle range of the lower second joint 46 (shown in FIG. 12). Compared with the universal joint of the first embodiment and the universal joint of the second embodiment, the universal joint of the third embodiment has a wider range of rotation angle.

The advantage of the present invention is that when the universal joint connects to the faucet, in addition to the original downward water outlet direction of the faucet, the user can tilt the water outlet direction of the water outlet device 50 upward by rotating the water outlet base 20. When the water outlet direction is downward, it is convenient for users to wash hands or clean items. When the water outlet direction is upward, it is convenient for users to gargle or wash their faces. In addition, the universal joint has a simple overall structure, a smaller size, and has the advantages of reduced cost and high versatility.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A universal joint comprising:
a connecting base comprising:
a connecting space formed in the connecting base;
an upper connecting hole connecting to an end of the connecting space; and
a lower connecting hole connecting to another end of the connecting space;
a water outlet base comprising:
an installing part comprising:
an installing space formed in the installing part;
an installing hole formed at an end of the installing part and connecting to the installing space; and
a through-hole formed at another end of the installing part and connecting to the installing space; and
a spherical joint, an end of the spherical joint connecting to the installing part; another end of the spherical joint mounted through the lower connecting hole and rotatably mounted in the connecting space of the connecting base; the spherical joint comprising:
a flow channel through the spherical joint; an end of the flow channel connecting to the through-hole and another end of the flow channel connecting to the connecting space and the upper connecting hole.

2. The universal joint as claimed in claim 1, wherein the spherical joint comprises an extending rod mounted through the lower connecting hole, protruding from the lower connecting hole of the connecting base, and connecting to the installing part; the flow channel is through the extending rod along an axial direction of the extending rod.

3. The universal joint as claimed in claim 1, wherein the connecting base comprises:
an upper sealing ring mounted in the connecting space and close to the upper connecting hole; the upper sealing ring sleeved on the spherical joint; and
a lower sealing ring mounted in the connecting space and close to the lower connecting hole; the lower sealing ring sleeved on the spherical joint.

4. The universal joint as claimed in claim 2, wherein the connecting base comprises:
an upper sealing ring mounted in the connecting space and close to the upper connecting hole; the upper sealing ring sleeved on the spherical joint; and
a lower sealing ring mounted in the connecting space and close to the lower connecting hole; the lower sealing ring sleeved on the spherical joint.

5. The universal joint as claimed in claim 2, wherein the spherical joint comprises:
an upper first joint rotatably mounted in the connecting space; the upper first joint comprising:
an upper joint holder concaved through the upper first joint;
an opening formed at an end of the upper joint holder; and
an upper water inlet formed at another end of the upper joint holder and opposite the opening in position;
an upper second joint rotatably mounted in the upper joint holder and protruding from the opening of the upper first joint; the upper second joint connecting to the extending rod; the flow channel through the upper second joint and connecting to the opening of the upper first joint.

6. The universal joint as claimed in claim 4, wherein the spherical joint comprises:
an upper first joint rotatably mounted in the connecting space; the upper first joint comprising:
an upper joint holder concaved through the upper first joint;
an opening formed at an end of the upper joint holder; and
an upper water inlet formed at another end of the upper joint holder and opposite the opening in position;
an upper second joint rotatably mounted in the upper joint holder and protruding from the opening of the upper first joint; the upper second joint connecting to the extending rod; the flow channel through the upper second joint and connecting to the opening of the upper first joint.

7. The universal joint as claimed in claim 5, wherein the spherical joint comprises:
a lower second joint formed at an end of the extending rod and opposite the upper second joint in position; the lower second joint rotatably connecting to the installing part; the flow channel through the upper second joint, the extending rod and the lower second joint in order.

8. The universal joint as claimed in claim 6, wherein the spherical joint comprises:
a lower second joint formed at an end of the extending rod and opposite the upper second joint in position; the lower second joint rotatably connecting to the installing part; the flow channel through the upper second joint, the extending rod and the lower second joint in order.

9. The universal joint as claimed in claim 7, wherein the spherical joint comprises:
a lower first joint mounted in the installing space of the installing part; the lower first joint comprising:
a lower joint holder; the lower second joint rotatably mounted through the lower joint holder; the lower joint holder connecting to the flow channel; and
a lower water outlet connecting to the installing space and the lower joint holder.

10. The universal joint as claimed in claim 8, wherein the spherical joint comprises:
a lower first joint mounted in the installing space of the installing part; the lower first joint comprising:
a lower joint holder; the lower second joint rotatably mounted through the lower joint holder; the lower joint holder connecting to the flow channel; and
a lower water outlet connecting to the installing space and the lower joint holder.

11. The universal joint as claimed in claim 9, wherein:
the upper first joint comprises:
an upper positioning ring mounted in the upper joint holder and close to the opening of the upper first joint; the upper positioning ring sleeved on the upper second joint; and
the lower first joint comprises:
a lower positioning ring mounted in the lower joint holder and away from the lower water outlet; the lower positioning ring sleeved on the lower second joint.

12. The universal joint as claimed in claim 10, wherein:
the upper first joint comprises:
an upper positioning ring mounted in the upper joint holder and close to the opening of the upper first joint; the upper positioning ring sleeved on the upper second joint; and
the lower first joint comprises:
a lower positioning ring mounted in the lower joint holder and away from the lower water outlet; the lower positioning ring sleeved on the lower second joint.

13. The universal joint as claimed in claim 1, wherein:
the installing part comprises a first phantom line extending along an axial direction of the installing hole;
the spherical joint comprises a second phantom line extending along an axial direction of the flow channel;
an angle between the first phantom line and the second phantom line is from 30 degrees to 180 degrees.

14. The universal joint as claimed in claim 12, wherein:
the installing part comprises a first phantom line extending along an axial direction of the installing hole;
the spherical joint comprises a second phantom line extending along an axial direction of the flow channel;
an angle between the first phantom line and the second phantom line is from 30 degrees to 180 degrees.

15. A faucet extender comprising:
the universal joint as claimed in claim 1; and
a water outlet device mounted in the installing hole of the installing part.

16. A faucet extender comprising:
the universal joint as claimed in claim 14; and
a water outlet device mounted in the installing hole of the installing part.

17. The faucet extender as claimed in claim 15, wherein the water outlet device is an on-off valve or a flow aerator.

18. The faucet extender as claimed in claim 16, wherein the water outlet device is an on-off valve or a flow aerator.
